(19) United States
(12) Patent Application Publication
(10) Pub. No.: US 2017/0109248 A1
(43) Pub. Date: Apr. 20, 2017

(54) SHARING BUS PORT BY MULTIPLE BUS HOSTS

(71) Applicant: Quanta Computer Inc., Taoyuan City (TW)

(72) Inventors: Chien-Hua YANG, Taoyuan City (TW); Yao-Yu CHAO, Taoyuan City (TW)

(21) Appl. No.: 14/918,070

(22) Filed: Oct. 20, 2015

(51) Int. Cl. G06F 11/30; G06F 13/40; G06F 13/38

(52) U.S. Cl. CPC G06F 11/3027; G06F 13/385; G06F 11/3048; G06F 11/3051; G06F 13/4022

(57) ABSTRACT

A system for sharing a bus port includes a first bus host, a second bus host, a multiplexer configured to select either the first bus host or the second bus host to connect to a bus port, and a port detector configured to detect whether a peripheral is connected or disconnect to the bus port. The first bus host is configured to: determine, in response detecting a peripheral connected to the bus port, which one of the first bus host or the second bus host the peripheral is dedicated to, and control, in response to the port detector determining that the peripheral is dedicated to the second bus host, the multiplexer to select the second bus host to connect to the bus port.

### BACKGROUND

Technical Field

This application relates to computer systems, and more particularly to a system and method for sharing a bus port by multiple bus hosts.

Background

Computer server systems in modern data centers are commonly mounted in specific configurations on server racks for which a number of computing modules, such as server trays, server chassis, server sleds, server blades, etc., are positioned and stacked relative on top of each other within the server racks. Rack mounted systems allow for vertical arrangement of the computing modules to use space efficiently. Generally, each computing module can slide into and out of the server rack, and various cables such as input/output (IO) cables, network cables, power cables, etc., connect to the computing modules at the front or rear of the rack. Each computing module contains one or more computer servers or may hold one or more computer server components. For example computing modules includes hardware circuitry for processing, storage, network controllers, disk drives, cable ports, power supplies, etc.

Peripheral devices can connect to the computing modules to input or extra information from the computing modules. Input peripheral devices interact with or send data to the computing modules. Common input peripherals include keyboards, computer mice, graphic tablets, touchscreens, barcode readers, image scanners, microphones, webcams, game controllers, light pens, and digital cameras. Output peripheral devices allow data to be extracted from the computing modules. Common output peripherals include computer displays, printers, projectors, and computer speakers. Some peripherals, such as touchscreens, can be used both as input and output devices.

Universal Serial Bus (USB) is an industry standard developed to define the cables, connectors, and communications protocols used in a communications bus for connection, communication, and power supply between computers and electronic devices. USB was designed to standardize the connection of computer peripherals for both communication and electrical power supply. USB has effectively replaced a variety of earlier interfaces, such as serial and parallel ports, as well as separate power connectors for low power devices. USB interfaces include USB 1.x, 2.x, and 3.x variants.

### SUMMARY

The following presents a simplified summary of one or more embodiments in order to provide a basic understanding of present technology. This summary is not an extensive overview of all contemplated embodiments of the present technology, and is intended to neither identify key or critical elements of all examples nor delineate the scope of any or all aspects of the present technology. Its sole purpose is to present some concepts of one or more examples in a simplified form as a prelude to the more detailed description that is presented later.

In some implementations, a system includes a first bus host, a second bus host, a multiplexer configured to select either the first bus host or the second bus host to connect to a bus port, and a port detector configured to detect whether a peripheral is connected to the bus port. The first bus host is configured to: determine, in response to the port detector detecting a peripheral connected to the bus port, which one of the first bus host or the second bus host the peripheral is dedicated to, and control, in response to determining that the peripheral is dedicated to the second bus host, the multiplexer to select the second bus host to connect to the bus port.

In some implementations, a method includes detecting, by a port detector, whether a peripheral is connected to a bus port. The method includes determining, by a first bus host, in response to the port detector detecting a peripheral connected to the bus port, which one of the first bus host or a second bus host that the peripheral is dedicated to. The method further includes controlling, by the first bus host, in response to determining that the peripheral is dedicated to the second bus host, a multiplexer to select the second bus host to connect to the bus port, where the multiplexer is configured to select either the first bus host or the second bus host to connect to the bus port.

In some implementations, a system includes a plurality of bus hosts that includes a management bus host and at least one system bus host, a multiplexer configured to select one of the plurality of bus hosts to connect to a bus port, and a port detector configured to detect whether a peripheral is connected to the bus port. The management bus host is configured to: determine, in response to the port detector detecting a peripheral connected to the bus port, which one of the plurality of bus hosts the peripheral is dedicated to, as a chosen bus host, and control the multiplexer to select the chosen bus host to connect to the bus port, if the chosen bus host is not the management bus host.

### BRIEF DESCRIPTION OF THE DRAWINGS

These and other sample aspects of the present technology will be described in the detailed description and the appended claims that follow, and in the accompanying drawings, wherein:

FIG. 1 illustrates a block diagram of an example system for sharing a bus port by multiple bus hosts;

FIG. 2 illustrates a flow chart of an example method for sharing a bus port by multiple bus hosts;

FIG. 3 illustrates an example methodology for sharing a bus port by multiple bus hosts; and

FIG. 4 illustrates a block diagram of an example computer system.

### DETAILED DESCRIPTION

The subject disclosure provides techniques for sharing a bus port by multiple bus hosts. Various aspects of the present technology are described with reference to the drawings. In the following description, for purposes of explanation, numerous specific details are set forth in order to provide a thorough understanding of one or more aspects. It is evident, however, that the present technology can be practiced without these specific details. In other instances, well-known structures and devices are shown in block diagram form in order to facilitate describing these aspects.

Current server systems often include a dual USB host design to support different types of USB peripherals that serve different purposes. In this dual USB host design, each of two USB hosts must connect to a separate USB port. Therefore, this design requires at least two separate USB ports. Different USB peripherals may be designed to be match with specific types of USB hosts. Therefore, a user attempting to connect a peripheral to one of the two separate USB ports must avoid connecting the peripheral to the wrong USB port.

A system that allows two or more bus hosts to share a bus port would save space on connector panels, cost of additional bus ports, as well as user error in selecting a correct bus port to connect a peripheral.

USB architecture includes a host, one or more downstream USB ports, and one or more peripheral devices connected in a tiered topology. Additional USB hubs may be included in the tiers. A USB host may implement one or more host controllers, where each host controller may connect to one or more USB ports. Up to 127 devices may be connected to a single host controller.

When a USB peripheral is first connected to a USB host, an enumeration process is started. The enumeration starts by sending a reset signal to the USB device. A data rate of the USB peripheral is determined during the reset signaling. After reset, the USB peripheral's information is read by the USB host and the USB peripheral is assigned a unique 7-bit address. If the USB peripheral is supported by the USB host, device drivers needed for communicating with the USB peripheral are loaded and the USB peripheral is set to a configured state. If the USB host is restarted, the enumeration process is repeated for all connected devices.

The host controller directs traffic flow to devices, so no USB device can transfer any data on the bus without an explicit request from the host controller. For example, in USB 2.0, the host controller polls the bus for traffic, usually in a round-robin fashion. The throughput of each USB port is determined by the slower speed of either the USB port or the USB peripheral connected to the USB port.

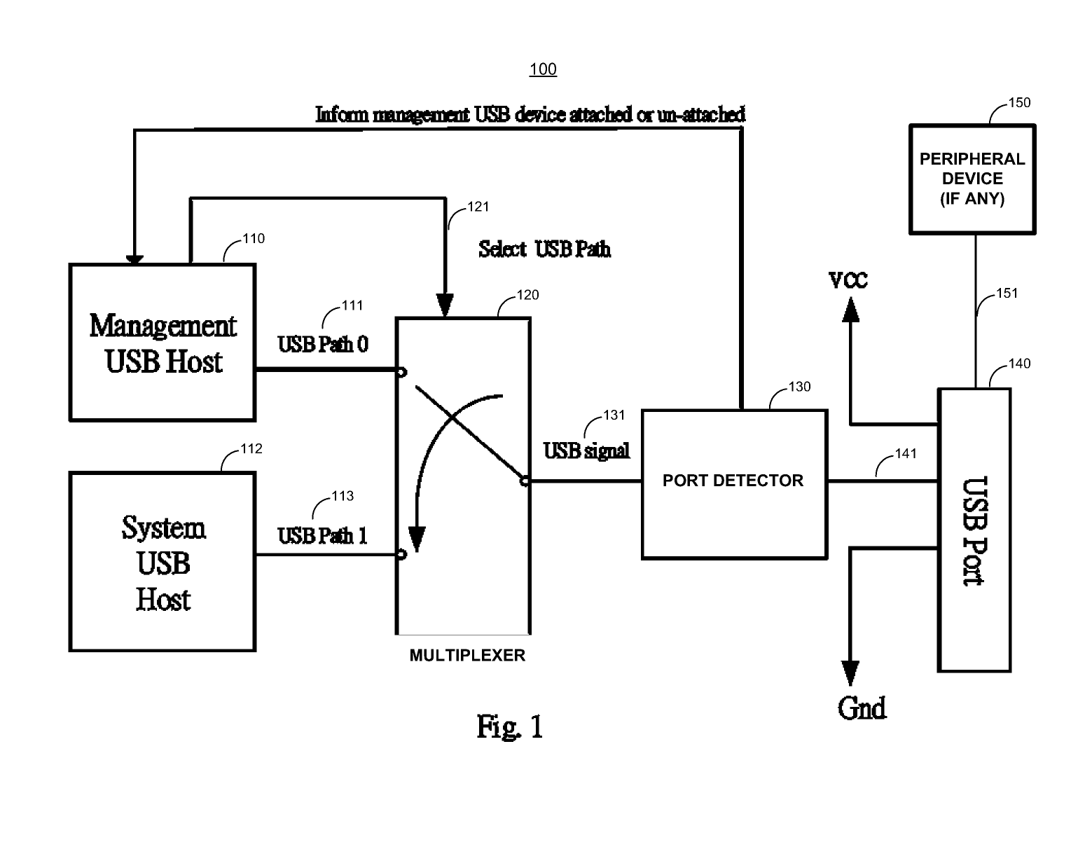

FIG. 1 illustrates a block diagram of an example system 100 for sharing a bus port by multiple bus hosts. The system 100 is shown using a USB interface, but can also be used with any other bus interface.

The system 100 includes a first bus host 110, a second bus host 112, a multiplexer 120, a port detector 130, and a bus port 140. FIG. 1 refers to the first bus host 110 as a management USB host and the second bus host 112 as a system USB host. Only two bus hosts are shown in FIG. 1, but three or more bus hosts can be used in the system 100.

The management USB host connects to the multiplexer 120 using path 111 and the system USB host connects to the multiplexer 120 using path 113. The port detector 130 connects to the multiplexer 120 using path 131 and to the bus port 140 using path 141.

A multiplexer is a device that selects one of several analog or digital input signals and forwards the selected input into a single output. A multiplexer can be considered as a multiple-input, single-output switch. A multiplexer makes it possible for several signals to share one device or resource.

The management USB host 110 controls the multiplexer 120 using the select USB path 121. The multiplexer 120 selects either the management USB host 110 or the system USB host 112 to connect to the bus port 140. The management USB host 110 determines which of the bus hosts 110, 112 to connect to the bus port 140 based on whether a peripheral is connected to the bus port 140. If a peripheral is connect to the bus port 140, the management USB host 110 further determines which of the bus hosts 110, 112 to connect to the bus port 140 based on which one of the bus hosts 110, 112 that the peripheral is dedicated to.

The port detector 130 is configured to detect whether a peripheral is connected to the bus port 140, by for example, a peripheral cable 151. The port detector 130 connects to the management USB host 110 to signal to the management USB host 110 whether a peripheral is connected to the bus port 140. In some aspects, the port detector 130 sends, in response to detecting that a peripheral is connected the bus port 140, an indicator to the management USB host 110.

In some implementations, the management USB host 110 is configured to control the multiplexer 120 to select the management USB host 110 to connect to the bus port 140 initially by default. In some aspects, the management USB host 110 is configured to control, in response to the port detector 130 detecting that the peripheral becomes disconnected, the multiplexer 120 to select the management USB host 110 to connect to the bus port 140.

In some implementations, the management USB host 110 receives information for the peripheral and compares the information with a lookup table to determine whether the peripheral is dedicated to the management USB host 110 or the system USB host 112.

The bus port 140 can receive a removable USB connector of a USB peripheral. There are several types of USB connector, including some that have been added while the specification progressed. The original USB specification detailed standard-A and standard-B plugs and receptacle. Various smaller connectors have been created for smaller devices such as digital cameras, smartphones, and tablet computers. Such smaller connectors include various types of mini-USB, micro-USB, etc. However, the invention is not limited to any particular type of port, and indeed not to a USB.

The bus port 140 connects to an integrated circuit power-supply pin (VCC) and to a ground. USB 1.x, 2.0 and 3.0 provide a 5 V supply on a single wire to power connected USB devices.

The data cables for USB 1.x and USB 2.x use a twisted pair to reduce noise and crosstalk. USB 3.0 cables contain twice as many wires as USB 2.x to support faster data transmission.

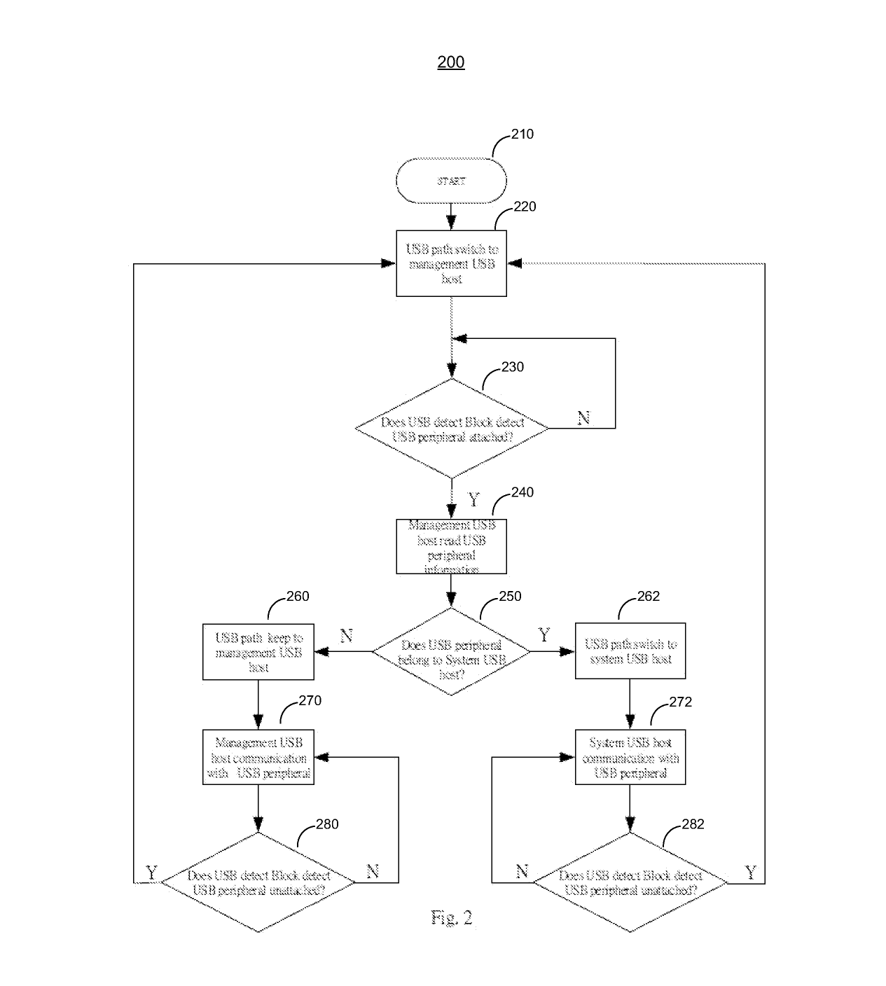

FIG. 2 illustrates a flow chart 200 of an example method for sharing a bus port by multiple bus hosts. The method starts at block 210. At block 220, the multiplexer 120 selects by default the management USB host 110, as shown in FIG. 1.

At block 230, the port detector 130 detects whether a peripheral is connected to the bus port 140. If a peripheral is not detected, the block 230 repeats until a peripheral is detected.

If the port detector 130 detects a peripheral, at block 240, the management USB host 110 receives information about the peripheral. In some aspects, the port detector 130 sends, in response to detecting that a peripheral is connected the bus port 140, an indicator to the management USB host 110.

At block 250, the management USB host 110 determines whether the peripheral is dedicated to management USB host 110 or to the system USB host 112.

If the peripheral is determined to be dedicated to the management USB host 110, at block 260, the management USB host 110 controls the multiplexer 130 to select the management USB host 110 to connect to the bus port 140, at block 270.

If the peripheral is determined to be dedicated to the system USB host 112, at block 262, the management USB host 110 controls the multiplexer 130 to select the system USB host 112 to connect to the bus port 140, at block 272. In some related aspects, if the peripheral is not dedicated to either the management USB host 110 or to the system USB host 112, the management USB host 110 controls the multiplexer 130 to select the management USB host 110 by default.

At blocks 280 and 282, the port detector 130 detects whether the peripheral becomes unattached. The multiplexer 120 does not change its selection if the peripheral stays connected. If the peripheral becomes unattached, the method continues to block 220.

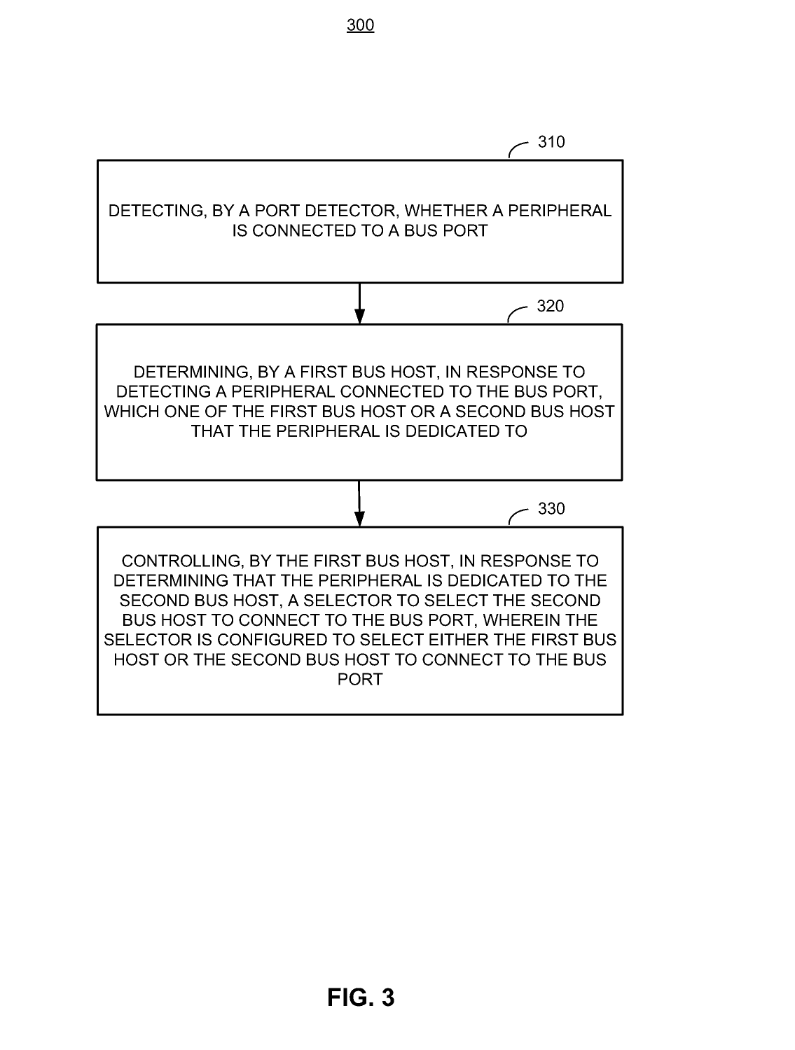

FIG. 3 illustrates an example methodology 300 for sharing a bus port by multiple bus hosts. The method 300 involves, at step 310, detecting, by a port detector, whether a peripheral is connected to a bus port.

The method 300 involves, at step 320, determining, by a first bus host, in response to detecting a peripheral connected to the bus port, which one of the first bus host or a second bus host that the peripheral is dedicated to. In some aspects, the port detector sends, in response to detecting that a peripheral is connected the bus port, an indicator to the first bus host. In some aspects, the first bus host receives information for the peripheral and compares the information with a lookup table to determine whether the peripheral is dedicated to the first bus host or the second bus host.

The method 300 involves, at step 330, controlling, by the first bus host, in response to determining that the peripheral is dedicated to the second bus host, a multiplexer to select the second bus host to connect to the bus port, wherein the multiplexer is configured to select either the first bus host or the second bus host to connect to the bus port.

In some implementations, the first bus host is configured to control the multiplexer to select the first bus host to connect to the bus port initially by default. In some aspects, the first bus host controls, in response to the port detector detecting that the peripheral is no longer connected, the multiplexer to select the first bus host to connect to the bus port.

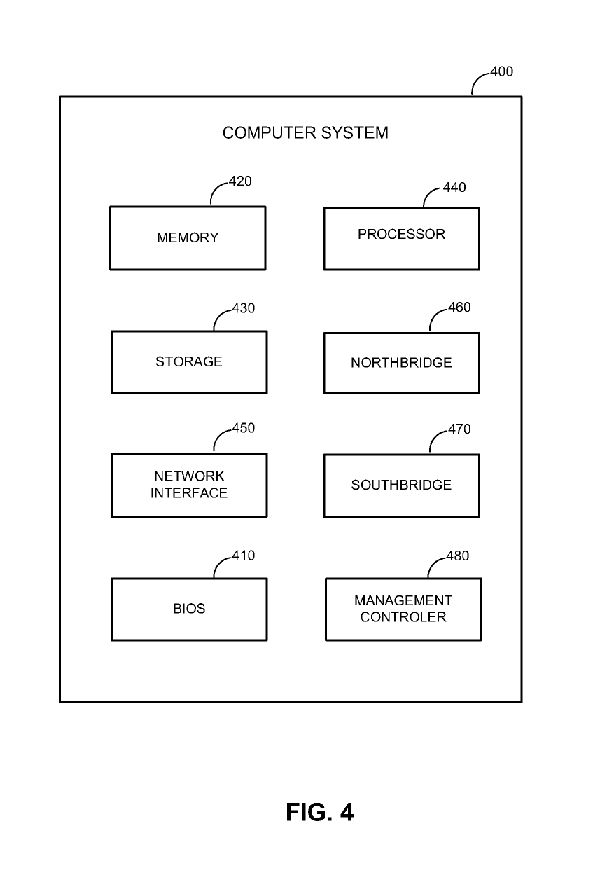

FIG. 4 illustrates a block diagram of an example computer system 400. The computer system 400 includes a processor 440, a network interface 450, a management controller 480, a memory 420, a storage 430, a BIOS 410, a northbridge 460, and a southbridge 470.

The computer system 400 is, for example, a server (e.g., a server in a server rack of a data center) or a personal computer. The processor (e.g., central processing unit (CPU)) 440 is a chip on a motherboard that retrieves and executes programming instructions stored in the memory 420. The processor 440 is a single CPU with a single processing core, a single CPU with multiple processing cores, or multiple CPUs. One or more buses (not shown) transmit instructions and application data between various computer components such as the processor 440, memory 420, storage 430, and networking interface 450.

The memory 420 includes any physical device used to temporarily or permanently store data or programs, such as various forms of random-access memory (RAM). The storage 430 includes any physical device for non-volatile data storage such as a HDD or a flash drive. The storage 430 can have a greater capacity than the memory 420 and can be more economical per unit of storage, but can also have slower transfer rates.

The BIOS 410 includes a Basic Input/Output System or its successors or equivalents, such as an Extensible Firmware Interface (EFI) or Unified Extensible Firmware Interface (UEFI). The BIOS 410 includes a BIOS chip located on a motherboard of the computer system 400 storing a BIOS software program. The BIOS 410 stores firmware executed when the computer system is first powered on along with a set of configurations specified for the BIOS 410. The BIOS firmware and BIOS configurations are stored in a non-volatile memory (e.g., NVRAM) or a ROM such as flash memory. Flash memory is a non-volatile computer storage medium that can be electronically erased and reprogrammed.

The BIOS 410 is loaded and executed as a sequence program each time the computer system 400 is started. The BIOS 410 recognizes, initializes, and tests hardware present in a given computing system based on the set of configurations. The BIOS 410 performs self-test, such as a Power-on-Self-Test (POST), on the computer system 400. This self-test tests functionality of various hardware components such as hard disk drives, optical reading devices, cooling devices, memory modules, expansion cards and the like. The BIOS addresses and allocates an area in the memory 420 in to store an operating system. The BIOS 410 then gives control of the computer system to the OS.

The BIOS 410 of the computer system 400 includes a BIOS configuration that defines how the BIOS 410 controls various hardware components in the computer system 400. The BIOS configuration determines the order in which the various hardware components in the computer system 400 are started. The BIOS 410 provides an interface (e.g., BIOS setup utility) that allows a variety of different parameters to be set, which can be different from parameters in a BIOS default configuration. For example, a user (e.g., an administrator) can use the BIOS 410 to specify clock and bus speeds, specify what peripherals are attached to the computer system, specify monitoring of health (e.g., fan speeds and CPU temperature limits), and specify a variety of other parameters that affect overall performance and power usage of the computer system.

The management controller 480 is a specialized microcontroller embedded on the motherboard of the computer system. For example, the management controller 480 is a baseboard management controller (BMC). The management controller 480 manages the interface between system management software and platform hardware. Different types of sensors built into the computer system report to the management controller 480 on parameters such as temperature, cooling fan speeds, power status, operating system status, etc. The management controller 480 monitors the sensors and has the ability to send alerts to an administrator via the network interface 450 if any of the parameters do not stay within preset limits, indicating a potential failure of the system. The administrator can remotely communicate with the management controller 480 to take some corrective action such as resetting or power cycling the system to restore functionality.

The northbridge 460 is a chip on the motherboard that can be directly connected to the processor 440 or is integrated into the processor 440. In some instances, the northbridge 460 and the southbridge 470 is combined into a single die. The northbridge 460 and the southbridge 470, manage communications between the processor 440 and other parts of the motherboard. The northbridge 460 manages tasks that require higher performance than the southbridge 470. The northbridge 460 manages communications between the processor 440, the memory 420, and video controllers (not shown). In some instances, the northbridge 460 includes a video controller.

The southbridge 470 is a chip on the motherboard connected to the northbridge 460, but unlike the northbridge 460, need not be directly connected to the processor 440. The southbridge 470 manages input/output functions, such as Universal Serial Bus (USB), audio, serial, BIOS, Serial Advanced Technology Attachment (SATA), Peripheral Component Interconnect (PCI) bus, PCI eXtended (PCI-X) bus, PCI Express bus, ISA bus, SPI bus, eSPI bus, SMBus, of the computer system 400. The southbridge 470 connects to or includes within the southbridge 470 the management controller 470, Direct Memory Access (DMAs) controllers, Programmable Interrupt Controllers (PICs), and a real-time clock. In some instances, the southbridge 470 directly connects to the processor 440, such as in the case where the northbridge 460 is integrated into the processor 440.

The networking interface 550 is any interface that supports wired or wireless Local Area Networks (LANs) or Wide Area Networks (WANs), such as Ethernet, Fibre Channel, Wi-Fi, Bluetooth, Firewire, the Internet, etc. For example, the networking interface 450 can include a network interface controller (NIC) for Ethernet. Ethernet has been the most widely used networking standard for connecting computers in both Local Area Networks (LANs) and Wide Area Networks (WANs). Ethernet defines a number of wiring and signaling standards for the physical layer (PHY), through means of network access at the Media Access Control (MAC)/Data Link Layer, and through a common addressing format. Ethernet enabled devices typically communicate by transmitting data packets, which comprise blocks of data that are individually sent and delivered.

The various illustrative logical blocks, modules, and circuits described in connection with the disclosure herein can be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor is a microprocessor, or in the alternative, any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor reads information from, and write information to, the storage medium. In the alternative, the storage medium is integral to the processor. The processor and the storage medium resides in an ASIC. The ASIC resides in a user terminal. In the alternative, the processor and the storage medium resides as discrete components in a user terminal.

In one or more exemplary designs, the functions described is implemented in hardware, software, firmware, or any combination thereof. If implemented in software, the functions are stored on or transmitted over as one or more instructions or code on a non-transitory computer-readable medium. Non-transitory computer-readable media includes both computer storage media and communication media including any medium that facilitates transfer of a computer program from one place to another. A storage media is any available media that can be accessed by a general purpose or special purpose computer. By way of example, and not limitation, such computer-readable media includes RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein can be applied to other variations without departing from the scope of the disclosure. Thus, the disclosure is not intended to be limited to the examples and designs described herein, but is to be accorded the widest scope consistent with the principles and novel features disclosed herein.

1. A system for sharing a bus port, comprising:
a first bus host;
a second bus host;
a selector (e.g. multiplexer) configured to select either the first bus host or the second bus host to connect to a bus port; and
a port detector configured to detect whether a peripheral is connected to the bus port;
the first bus host being configured to:
determine, in response to the port detector detecting a peripheral connected to the bus port, which one of the first bus host or the second bus host the peripheral is dedicated to, and
control, in response to determining that the peripheral is dedicated to the second bus host, the multiplexer to select the second bus host to connect to the bus port.

2. The system of claim 1, wherein the first bus host is configured to control the multiplexer to select the first bus host to connect to the bus port initially by default.

3. The system of claim 1, wherein the first bus host is configured to control, in response to determining that the peripheral is not dedicated to either the first bus host or to the second bus host, the multiplexer to select the first bus host.

4. The system of claim 1, wherein the first bus host is configured to control, in response to the port detector detecting that the peripheral becomes disconnected, the multiplexer to select the first bus host to connect to the bus port.

5. The system of claim 1, wherein the port detector sends, in response to detecting that a peripheral is connected the bus port, an indicator to the first bus host.

6. The system of claim 1, wherein the first bus host receives information for the peripheral and compares the information with a lookup table to determine whether the peripheral is dedicated to the first bus host or the second bus host.

7. A method for sharing a bus port, comprising:
detecting, by a port detector, whether a peripheral is connected to a bus port;
determining, by a first bus host, in response to the port detector detecting a peripheral connected to the bus port, which one of the first bus host or a second bus host that the peripheral is dedicated to; and
controlling, by the first bus host, in response to determining that the peripheral is dedicated to the second bus host, a multiplexer to select the second bus host to connect to the bus port, wherein the multiplexer is configured to select either the first bus host or the second bus host to connect to the bus port.

8. The method of claim 7, further comprising controlling, by the first bus host, the multiplexer to select the first bus host to connect to the bus port initially by default.

9. The method of claim 7, further comprising controlling, by the first bus host, in response to determining that the peripheral is not dedicated to either the first bus host or to the second bus host, the multiplexer to select the first bus host.

10. The method of claim 7, further comprising controlling, by the first bus host, in response to the port detector detecting that the peripheral becomes disconnected, the multiplexer to select the first bus host to connect to the bus port.

11. The method of claim 7, further comprising sending, by the port detector, in response to detecting that a peripheral is connected the bus port, an indicator to the first bus host.

12. The method of claim 7, further comprising receiving, by the first bus host, information for the peripheral and compares the information with a lookup table to determine whether the peripheral is dedicated to the first bus host or the second bus host.

13. A system for sharing a bus port, comprising:
a plurality of bus hosts comprising a management bus host and at least one system bus host;
a multiplexer configured to select one of the plurality of bus hosts to connect to a bus port; and
a port detector configured to detect whether a peripheral is connected to the bus port;
the management bus host being configured to:
determine, in response to the port detector detecting a peripheral connected to the bus port, which one of the plurality of bus hosts the peripheral is dedicated to, as a chosen bus host, and
control the multiplexer to select the chosen bus host to connect to the bus port, if the chosen bus host is not the management bus host.

14. The system of claim 13, wherein the management bus host is configured to control the multiplexer to select the first bus host to connect to the bus port initially by default.

15. The system of claim 13, wherein the management bus host is configured to control, in response to determining that the peripheral is not dedicated to either the management bus host or to the system bus host, the multiplexer to select the management bus host.

16. The system of claim 13, wherein the management bus host is configured to control, in response to the port detector detecting that the peripheral becomes disconnected, the multiplexer to select the management bus host to connect to the bus port.

17. The system of claim 13, wherein the port detector sends, in response to detecting that a peripheral is connected the bus port, an indicator to the management bus host.

18. The system of claim 13, wherein the management bus host receives information for the peripheral and compares the information with a lookup table to determine which one of the plurality of bus hosts the peripheral is dedicated to.
